(19) United States
(12) Patent Application Publication
(10) Pub. No.: US 2011/0044425 A1
(43) Pub. Date: Feb. 24, 2011

(54) SPECTRAL PURITY FILTERS FOR USE IN A LITHOGRAPHIC APPARATUS

(75) Inventors: Martin Jacobus Johan Jak, Eindhoven (NL); Vadim Yevgenyevich Banine, Deurne (NL); Maarten Marinus Johannes Wilhelmus Van Herpen, Heesch (NL); Wouter Anthon Soer, Nijmegen (NL); Andrey Mikhailovich Yakunin, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/860,634

(22) Filed: Aug. 20, 2010

Related U.S. Application Data
(60) Provisional application No. 61/235,808, filed on Aug. 21, 2009.

(51) Int. Cl. G03B 27/72; G02B 5/20; G21K 3/00; G21K 5/00

(52) U.S. Cl. 378/34; 359/885; 359/350; 378/156; 355/71; 250/503.1

(57) ABSTRACT

A spectral purity filter includes a plurality of apertures extending through a member. The apertures are arranged to suppress a first wavelength of radiation and to allow at least a portion of a second wavelength of radiation to be transmitted through the apertures. The second wavelength of radiation is shorter than the first wavelength of radiation. The apertures extend though the member in different directions in order to be substantially in alignment with radiation constituting a non-parallel beam of radiation.

### CROSS-REFERENCE TO RELATED APPLICATIONS

This application claims the benefit of priority from U.S. Provisional Patent Application Ser. No. 61/235,808, filed Aug. 21, 2009, the content of which is incorporated herein by reference in its entirety.

### FIELD

The present invention relates to spectral purity filters (SPFs), and in particular, although not restricted to, spectral purity filters for use in a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (e.g. resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to be able to project ever smaller structures onto substrates, it has been proposed to use extreme ultraviolet radiation (EUV) having a wavelength within the range of 5-20 nm, for example within the range of 13-14 nm or 6-7 nm.

Extreme ultraviolet radiation (amongst, for example, other wavelengths of radiation) may be produced using, for example, a plasma. The plasma may be created for example by directing a laser at particles of a suitable material (e.g. tin), by directing a laser at a stream of a suitable gas or vapor such as Xe gas or Li vapor, or by creating an electrical discharge. The resulting plasma emits extreme ultraviolet radiation (or beyond EUV radiation), which is collected using a collector such as a mirrored normal incidence collector, or a mirrored grazing incidence collector, which receives the extreme ultraviolet radiation and focuses the radiation into a beam.

Practical EUV Sources, such those which generate EUV radiation using a plasma, do not only emit desired ‘in-band’ EUV radiation, but also undesirable ‘out-of-band’ radiation. This out-of-band radiation is most notably in the deep ultra violet (DUV) radiation range (100-400 nm). Moreover, in the case of some EUV sources, for example laser produced plasma EUV sources, the radiation from the laser, usually at 10.6 μm, presents a significant amount of out-of-band radiation.

In a lithographic apparatus, spectral purity is desired for several reasons. One reason is that resist is sensitive to out-of-band wavelengths of radiation, and thus the image quality of patterns applied to the resist may be deteriorated if the resist is exposed to such out-of-band radiation. Furthermore, out-of-band radiation infrared radiation, for example the 10.6 μm radiation in some laser produced plasma sources, may lead to unwanted and unnecessary heating of the patterning device, substrate and optics within the lithographic apparatus. Such heating may lead to damage of these elements, degradation in their lifetime, and/or defects or distortions in patterns projected onto and applied to a resist-coated substrate.

In order to overcome these potential problems, several different transmissive spectral purity filters have been proposed which substantially prevent the transmission of infrared radiation, while simultaneously allowing the transmission of EUV radiation. Some of these proposed spectral purity filters comprise a thin metal layer or foil which is substantially opaque to, for example, infrared radiation, while at the same time being substantially transparent to EUV radiation. These and other spectral purity filters may also be provided with one or more apertures. The size and spacing of the apertures, as well as the dimensions of those apertures may be chosen such that infrared radiation is diffracted or scattered by the apertures (and thereby suppressed), while EUV radiation is transmitted through the apertures. A spectral purity filter provided with apertures may have a higher EUV transmittance than a spectral purity filter which is not provided with apertures. This is because EUV radiation will be able to pass through an aperture more easily than it would through a given thickness of metal foil or the like.

In a lithographic apparatus it is desirable to minimize the losses in intensity of radiation which is being used to apply a pattern to a resist coated substrate. One reason for this is that, ideally, as much radiation as possible should be available for applying a pattern to a substrate, for instance to reduce the exposure time and increase throughput. At the same time, it is desirable to minimize the amount of undesirable (e.g. out-of-band) radiation that is passing through the lithographic apparatus and which is incident upon the substrate.

### SUMMARY

It is an aspect of the present invention to provide an improved or alternative spectral purity filter or spectral purity filter arrangement. The spectral purity filter or spectral purity filter arrangement is configured to suppress radiation having a first wavelength (for example, undesirable radiation, such as infrared radiation), while at the same time allowing the transmission of radiation having a second wavelength (for example, desirable radiation, such as EUV radiation that is used to apply pattern to a resist coated substrate). Desirably, the spectral purity filter and spectral purity filter arrangement are arranged to transmit more radiation having a second wavelength in comparison with prior art spectral purity filters or spectral purity filter arrangements.

According to an aspect of the present invention there is provided a spectral purity filter, comprising: a plurality of apertures extending through a member of the spectral purity filter, the apertures being arranged to suppress a first wavelength of radiation (e.g. by providing apertures having dimensions suitable for diffracting or scattering the radiation, or absorbing the radiation in sidewalls of the apertures) and to allow at least a portion of a second wavelength of radiation to be transmitted through the aperture, the second wavelength of radiation being shorter than the first wavelength of radiation; wherein the apertures extend though the member in different directions in order to be substantially in alignment with radiation constituting a non-parallel beam of radiation. The member may be a plate, a foil, and/or membrane.

Additionally or alternatively, the member may be substantially planar and define a plane, apertures within the spectral purity filter being angled at different angles with respect to a normal of that plane, such that the apertures extend though the spectral purity filter in different directions.

The spectral purity filter may have a thickness of about 5 μm to about 20 μm.

If the first wavelength is in the infrared part of the spectrum, the apertures may, for instance, have a diameter in the range of about 2 μm to about 10 μm, more specifically in the range of about 2 μm to about 10 μm and even more specifically in the range of about 2 μm to about 10 μm. Depending on other parameters of the spectral purity filter, such apertures may be suitable for suppressing infrared wavelengths.

The spectral purity filter may be comprise of a plurality of planar segments defining a plurality of planes, the apertures within each segment extending substantially perpendicular to the plane defined by that segment, and the planar segments being angled with respect to one another such that the apertures extend though the spectral purity filter in different directions.

The spectral purity filter may be substantially curved, the apertures within the spectral purity filter being aligned substantially perpendicularly with respect to the curve, such that the apertures extend though the spectral purity filter in different directions.

The apertures may have sidewalls, the sidewalls being arranged to be substantially in alignment with radiation constituting a non-parallel beam of radiation.

The direction in which the apertures extend may be arranged to be in substantial alignment with a point (e.g. an emission point, a focus point a virtual focus point). The sidewalls of the apertures may also be in substantial alignment with this point.

According to an aspect of the present invention there is provided a spectral purity filter arrangement, comprising: a spectral purity filter, comprising: a plurality of apertures extending through a member, the apertures being arranged to suppress a first wavelength of radiation (e.g. by providing apertures having dimensions suitable for diffracting or scattering the radiation, or absorbing the radiation in sidewalls of the apertures) and to allow at least a portion of a second wavelength of radiation to be transmitted through the aperture, the second wavelength of radiation being shorter than the first wavelength of radiation, the member being substantially planar and defining a plane, the apertures extending substantially perpendicularly to the plane, and wherein the spectral filter arrangement further comprises: a deformation arrangement constructed and arranged to deform the spectral purity filter in order to, in use, form a substantially curved member, and such that the apertures extend though the spectral purity filter in different directions in order to be substantially in alignment with radiation constituting a non-parallel beam of radiation, the deformation arrangement comprising an electrostatic arrangement.

The electrostatic arrangement may comprise a voltage source and an electrode configuration, the voltage source being in connection with the member and the electrode configuration. The spectral purity filter arrangement may further comprise a controller configured to control the voltage source to control deformation of the member, the controller being arranged to control the voltage source in response to a feedback signal received by the controller, the feedback signal being at least indicative of: a transmission of the second wavelength of radiation of the beam of radiation; or a degree of curvature of the member. The member may be a plate, a foil, and/or membrane. It may be possible to thereby control the deforming of the member. At least a part of the electrode configuration is located outside of an beam diameter of the beam of radiation.

At least a part of the electrode configuration may be located outside of a beam diameter of the beam of radiation.

The electrode configuration may be provided with a hole through which the beam of radiation may pass.

The electrode configuration may comprise an electrode grid or electrode mesh.

When curved, the direction in which the apertures extend may be arranged to be in substantial alignment with a point (e.g. an emission point, a focus point a virtual focus point). The sidewalls of the apertures may also be in substantial alignment with this point.

In accordance with the spectral purity filter or spectral purity filter arrangement of any aspect of the present invention, the first wavelength of radiation may have a wavelength that is in the infrared part of the electromagnetic spectrum.

In accordance with the spectral purity filter or spectral purity filter arrangement of any aspect of the present invention, the first wavelength of radiation may have a wavelength that is approximately 10.6 μm. This is a wavelength of radiation often used in, for example, laser produced plasma radiation sources. It is desirable to suppress this wavelength.

In accordance with the spectral purity filter or spectral purity filter arrangement of any aspect of the present invention, the second wavelength of radiation may have a wavelength that is substantially equal to or shorter than radiation having a wavelength in the EUV part of the electromagnetic spectrum.

According to an aspect of the present invention there is provided a lithographic apparatus or a radiation source having the spectral purity filter, or spectral purity filter arrangement, according to embodiments of the present invention.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a more detailed but schematic depiction of the lithographic apparatus shown in FIG. 1;

FIG. 3 schematically depicts a transmissive spectral purity filter;

FIG. 4 schematically depicts a side-on view of the spectral purity filter of FIG. 3 together with radiation constituting a parallel beam of radiation passing through the spectral purity filter;

FIG. 5 schematically depicts a side-on view of the spectral purity filter of FIG. 3 together with radiation constituting a non-parallel (i.e. divergent or convergent) beam of radiation passing through the spectral purity filter;

FIG. 6 schematically depicts a side-on view of a transmissive spectral purity filter according to an embodiment of the present invention, together with radiation constituting a non-parallel (i.e. divergent or convergent) beam of radiation passing through the spectral purity filter;

FIG. 7 schematically depicts a side-on view of a transmissive spectral purity filter according to an embodiment of the present invention, together with radiation constituting a non-parallel (i.e. divergent or convergent) beam of radiation passing through the spectral purity filter;

FIG. 8 schematically depicts a side-on view of a transmissive spectral purity filter according to an embodiment of the present invention, together with radiation constituting a non-parallel (i.e. divergent or convergent) beam of radiation passing through the spectral purity filter;

FIG. 9 schematically depicts a spectral purity filter arrangement in accordance with an embodiment of the present invention, the spectral purity filter arrangement comprising a spectral purity filter and a deformation arrangement for deforming (e.g. bending) the spectral purity filter; and

FIG. 10 schematically depicts the spectral purity filter arrangement of FIG. 9 in use, together with radiation constituting a non-parallel (i.e. divergent or convergent) beam of radiation passing through the spectral purity filter when the spectral purity filter is deformed by the deformation arrangement.

### DETAILED DESCRIPTION

FIG. 1 schematically depicts a lithographic apparatus 2 according to an embodiment of the invention. The apparatus 2 comprises: an illumination system (illuminator) IL configured to condition a radiation beam B (e.g. EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus 2, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

Examples of patterning devices include masks and programmable mirror arrays. Masks are well known in lithography, and typically in a EUV radiation (or beyond EUV) lithographic apparatus would be reflective. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. Usually, in a EUV (or beyond EUV) radiation lithographic apparatus the optical elements will be reflective. However, other types of optical element may be used. The optical elements may be in a vacuum. Any use of the term “projection lens” herein may be considered as synonymous with the more general term “projection system”.

As here depicted, the apparatus 2 is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus. The source SO and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may comprise various other components, such as an integrator and a condenser. The illuminator IL may be used to condition the radiation beam B to have a desired uniformity and intensity distribution in its cross-section.

The radiation beam B is incident on the patterning device (e.g., mask MA), which is held on the support structure (e.g., mask table MT), and is patterned by the patterning device. Having been reflected by the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus 2 could be used in at least one of the following modes:

In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

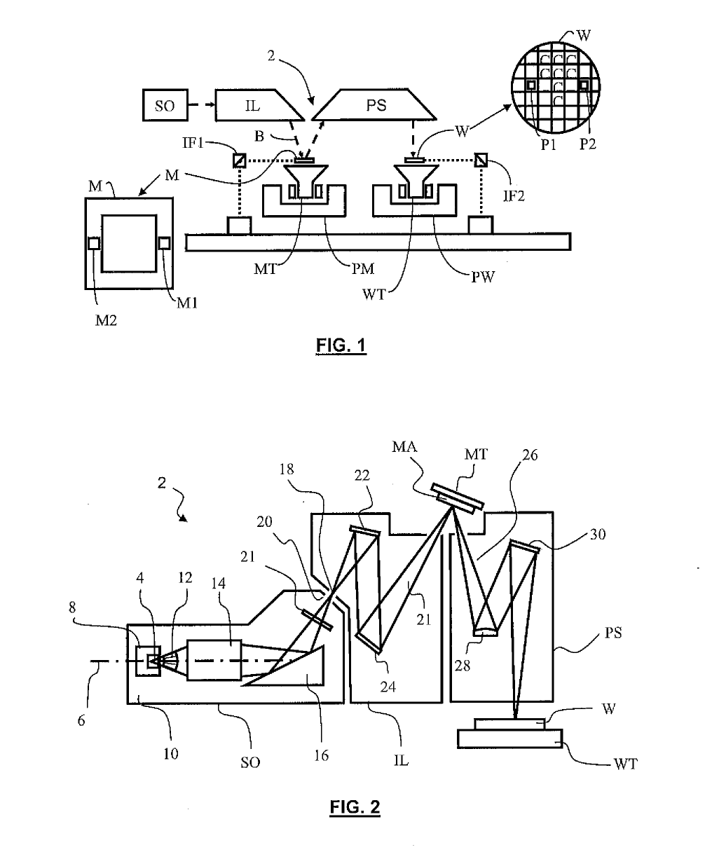

FIG. 2 shows the lithographic apparatus 2 in more detail, including a radiation source SO, an illuminator IL (sometimes referred to as an illumination system), and the projection system PS. The radiation source SO includes a radiation emitter 4 which may comprise a discharge plasma. EUV radiation may be produced by a gas or vapor, such as Xe gas or Li vapor in which very hot plasma is created to emit radiation in the EUV radiation range of the electromagnetic spectrum. The very hot plasma is created by causing partially ionized plasma of an electrical discharge to collapse onto an optical axis 6. Partial pressures of e.g. 10 Pa of Xe or Li vapor or any other suitable gas or vapor may be required for efficient generation of the radiation. In some embodiments, tin may be used. FIG. 2 illustrates a discharge produced plasma (DPP) radiation source SO. It will be appreciated that other sources may be used, such as for example a laser produced plasma (LPP) radiation source.

The radiation emitted by radiation emitter 4 is passed from a source chamber 8 into a collector chamber 10. The collector chamber 10 includes a contamination trap 12 and grazing incidence collector 14 (shown schematically as a rectangle). Radiation allowed to pass through the collector 14 is reflected off a grating spectral filter 16 to be focused in a virtual source point 18 at an aperture 20 in the collector chamber 10. Before passing through the aperture 20, the radiation passes through a spectral purity filter 21. Different embodiments of a spectral purity filter 21 are described in more detail below. From collector chamber 10, a beam of radiation 21 is reflected in the illuminator IL via first and second reflectors 22, 24 onto a reticle or mask MA positioned on reticule or mask table MT. A patterned beam of radiation 26 is formed which is imaged in projection system PS via first and second reflective elements 28, 30 onto a substrate W held on a substrate table WT.

It will be appreciated that more or fewer elements than shown in FIG. 2 may generally be present in the source SO, illumination system IL, and projection system PS. For instance, in some embodiments the illumination system IL and/or projection system PS may contain a greater or lesser number of reflective elements or reflectors.

It is known to use a spectral purity filter in a lithographic apparatus to filter out undesirable (e.g. out-of-band) wavelength components of a radiation beam. For instance, it is known to provide a spectral purity filter comprising one or more apertures. The diameter of each aperture is chosen such that the aperture diffracts one or more undesirable wavelengths of radiation (i.e. radiation having a first wavelength), for example by providing apertures having dimensions suitable for diffracting or scattering the radiation, or absorbing the radiation in sidewalls of the apertures, while allowing one or more desirable wavelengths of radiation (i.e. radiation having a second wavelength) to pass through the apertures. For instance, the undesirable radiation may comprise infrared radiation, whereas the desirable radiation may comprise EUV or beyond EUV radiation.

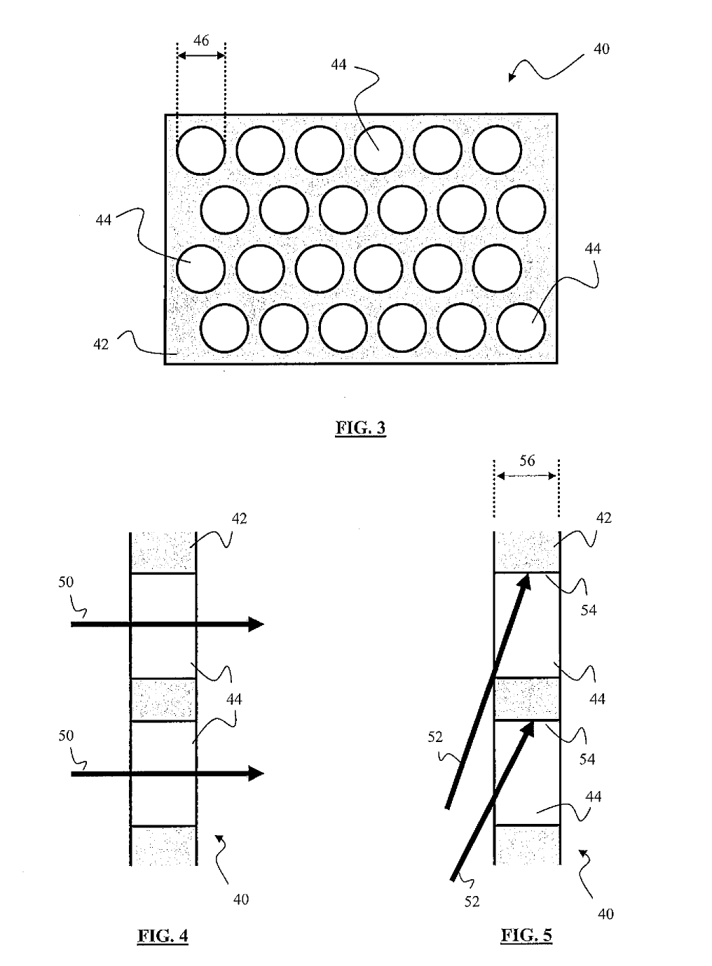

FIG. 3 schematically depicts a known spectral purity filter 40. The spectral purity filter 40 comprises a plate 42 in which a periodic array of circular apertures 44 is provided. The diameter 46 of the apertures 44 is selected such that a first wavelength of radiation to be suppressed is substantially diffracted or scattered at the entrance of each aperture 44, or within the aperture 44, while radiation of a second, shorter wavelength is transmitted through the apertures 44. The diameter 46 of the apertures 44 may be, for example, in the range of 1-100 μm, in order to suppress radiation being a comparable wavelength. More specifically, if the first wavelength is in the infrared part of the spectrum, for instance if the first wavelength is about 9.4 μm or 10.6 μm, the apertures may, for instance, have a diameter in the range of about 2 μm to about 10 μm, more specifically in the range of about 2 μm to about 10 μm and even more specifically in the range of about 2 μm to about 10 μm. Depending on other parameters of the spectral purity filter, such apertures may be suitable for suppressing infrared wavelengths.

The plate 42 can be formed from any suitable material. A foil or membrane may be used instead of, or in addition to, the plate 42. The plate 42 (or whichever structure is used) may be substantially opaque to the first wavelength of radiation or range of wavelengths which the spectral purity filter 40 is designed to suppress. For instance, the plate 42 may reflect or absorb the first wavelength, for example a wavelength in the infrared range of the electromagnetic spectrum. The plate 42 may also be substantially opaque to one or more second wavelengths of radiation which the spectral purity filter 40 is designed to transmit, for example a wavelength in the EUV range of the electromagnetic spectrum. However, the spectral purity filter 40 can also be formed from a plate 42 which is substantially transparent to the one or more first wavelengths that the spectral purity filter 40 is designed to transmit. This may increase the transmittance of the spectral purity filter 40 with respect to the one or more wavelengths which the spectral purity filter 40 is designed to transmit. An example of a material which may form the plate 42 of the spectral purity filter 40 is a metal. Another example is a thin foil that is substantially transparent to EUV radiation.

The apertures 44 in the spectral purity filter 40 are arranged in a hexagonal pattern. This arrangement may be preferred, since it gives the closest packing of circular apertures, and therefore the highest transmittance for the spectral purity filter 40. However, other arrangements of the apertures are also possible, for example square, and rectangular or other periodic or aperiodic arrangements may be used. For instance, in the case of an aperiodic array, a random pattern may be employed. The apertures (in whatever arrangement) may be circular in shape, or, for example, elliptical, hexagonal, square, rectangular, or any other suitable shape.

FIG. 4 schematically depicts the spectral purity filter 40 of FIG. 3 in a side-on and part-section view. The plate 42 in which the apertures 44 are provided is substantially planar in shape, and thus defines a plane. Manufacturing methods (e.g. drilling or the like) for the provision of apertures 44 in the plate 42 of a spectral purity filter 40 usually result in apertures 44 that extend through the spectral purity filter 40 in a direction that is substantially perpendicular to the plane defined by the plate 42 (i.e. apertures that each have a central axis that is perpendicular to a plane defined by the spectral purity filter 40).

FIG. 4 further depicts radiation 50. The radiation 50 constitutes radiation from a parallel beam of radiation. When the radiation 50 is incident upon the spectral purity filter 40 in a direction which is substantially perpendicular to a plane defined by the spectral purity filter 40, the radiation 50 readily passes through the apertures 44 of the spectral purity filter 40. However, this is not the case if the radiation beam incident on the spectral purity filter 40 constitutes a non-parallel (i.e. convergent or divergent) beam of radiation.

FIG. 5 schematically depicts the same side-on and part-section view of the spectral purity filter 40 shown in and described with reference to FIG. 4. In contrast to FIG. 4, however, in FIG. 5 radiation that is directed towards the spectral purity filter 40 is not directed in a direction which is substantially perpendicular (i.e. normal to) the plane defined by the spectral purity filter 40. Instead, radiation 52 shown in FIG. 5 constitutes a non-parallel beam of radiation, and in this embodiment radiation 52 constitutes a divergent beam of radiation. Because the radiation 52 constitutes a divergent beam of radiation, the radiation 52 does not readily pass through the apertures 44 of the spectral purity filter 40, but instead is incident upon and, for example, absorbed by or scattered by sidewalls 54 of the apertures 44.

While some radiation may be less divergent than the radiation 52 shown in FIG. 5, and may thus pass through the apertures 44, the transmission of a non-parallel beam of radiation through the spectral purity filter will be reduced in comparison with the transmission of a parallel beam of radiation. For instance, the reduction in transmission may, in some circumstances, be 10% or greater.

A solution to the problem of reduction in transmission of non-parallel radiation may be achieved, for example, by reducing the depth 56 of the plate 42 and thus the depth of the apertures 44. Such a reduction in depth will reduce the length of the sidewalls 54 of the apertures 44, thus allowing more radiation to pass through the apertures 44. However, a reduction in depth of the plate 42 may result in less suppression of undesirable radiation and/or a more fragile spectral purity filter.

One or more potential problems of the prior art (whether identified herein or elsewhere) may be obviated or mitigated with a spectral purity filter according to the present invention. According to an embodiment of the present invention, the spectral purity filter may comprise apertures extending through the spectral purity filter. Each aperture may be arranged to suppress a first wavelength of radiation, for example infrared radiation (e.g. by providing apertures having dimensions suitable for diffracting or scattering the radiation, or absorbing the radiation in sidewalls of the apertures) and to allow at least a portion of a second wavelength of radiation to be transmitted through the aperture (for example, a desired wavelength of radiation, such as for example EUV radiation, or UV radiation). The second wavelength of radiation is shorter than the first wavelength of radiation in order to achieve this effect. In contrast with prior art spectral purity filters, the apertures of the spectral purity filter according to an embodiment of the present invention extend through the spectral purity filter in different directions in order to be substantially in alignment with radiation constituting a non-parallel (i.e. convergent or divergent) beam of radiation.

By ensuring that the apertures extend in directions which are aligned with radiation constituting a non-parallel beam of radiation (and which, in use, is to be directed at the spectral purity filter), less radiation is lost due to absorption or scattering of radiation from sidewalls of the apertures. Since radiation may no longer be incident on the side walls, the depth of the spectral purity filter, and thus the length of the walls of the apertures, can be increased, without reducing the transmission of radiation through the spectral purity filter. This may be advantageous, since any increase in the depth of the spectral purity filter may allow the spectral purity filter to be more effective in the suppression of undesirable radiation, and/or to be subjected to a high heat load without risk (or by reducing the risk) of damage due to such a high heat load.

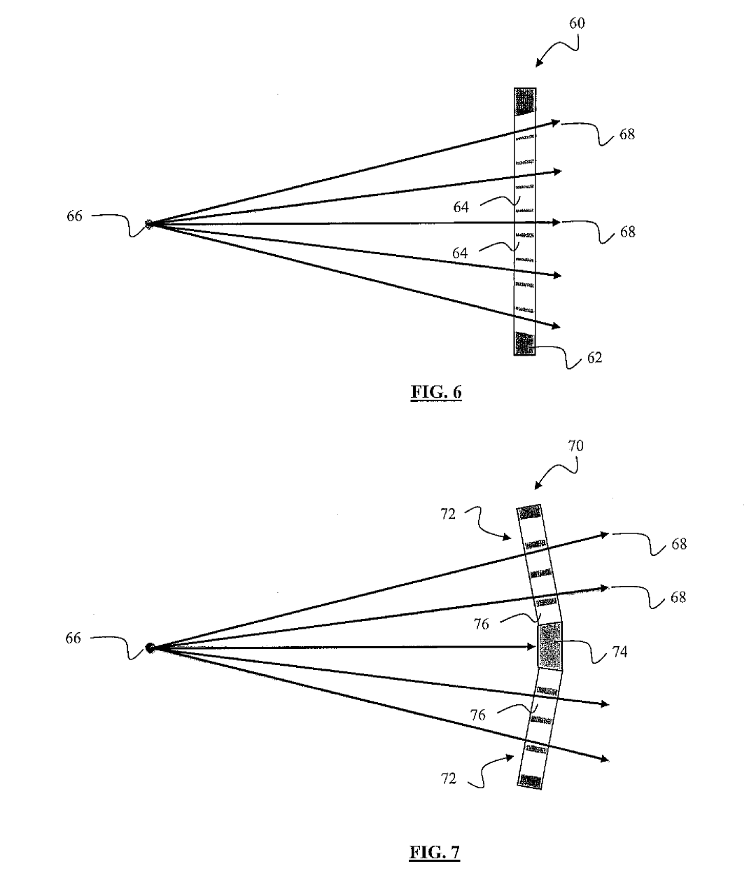

Specific embodiments of the present invention will now be described, by way of example only, with reference to FIGS. 6 to 10.

FIG. 6 schematically depicts a side-on and part section view of a spectral purity filter 60 in accordance with an embodiment of the present invention. The spectral purity filter 60 comprises a planar member 62, which may be for example a membrane, plate or foil or the like. Apertures 64 are provided in the planar member 62 and extend through the spectral purity filter 60. Each aperture 64 is arranged to suppress a first wavelength of radiation (for example, undesirable radiation such as infrared radiation) and to allow at least a portion of a second wavelength of radiation (e.g. desired radiation, such as EUV radiation) to be transmitted through the aperture 64, the second wavelength of radiation being shorter than the first wavelength of radiation. This may be achieved by an appropriate selection of the diameter of the openings of each aperture 64. For example, if the apertures have a diameter which substantially corresponds to a certain wavelength of radiation, that certain wavelength of radiation (for example, radiation of a first wavelength) will be diffracted by the apertures 64, and substantially suppressed (i.e. prevented from being transmitted through the spectral purity filter 60). In general, in order to suppress radiation having the first wavelength, the apertures 64 may have dimensions suitable for diffracting or scattering the radiation having the first wavelength, or absorbing the radiation having the first wavelength in sidewalls of the apertures 64.

The planar member 62 (and, in general, the spectral purity filter 60) defines a plane. The apertures 64 within the spectral purity filter 60 are angled at different angles with respect to a normal of the plane, so that the apertures 64 extend through the spectral purity filter 60 in different directions. For instance, a central longitudinal axis of each aperture 64 may be directed towards (i.e. be aligned with) a point of emission or focus point 66 of radiation 68. Side walls of the aperture 64 are also aligned with the point of emission or focus point 66, such that the apertures 64 are tapered inwardly towards the point of emission or focus point 66, as illustrated in FIG. 6.

The divergent radiation 68 emitted from the point of emission or focus point 66 is readily transmitted through the apertures 64, because the apertures 64 (and the side walls of those apertures 64) are aligned with the point of emission or focus point 66. Because the apertures 64 (and the side walls of those apertures 64) are aligned with the point of emission or focus point 66, little or no radiation 66 is incident upon and absorbed or scattered by the sidewalls of the apertures 64.

In other embodiments (not shown), the apertures, and/or the side walls of those apertures, may not be aligned with the point of emission or focus point of radiation, but may instead be aligned with the radiation that is to be directed towards the spectral purity filter. For instance, radiation directed towards spectral purity filter may be directed or re-directed of one or more mirrors or lenses before being incident on the spectral purity filter thus making (in this example) the alignment of the apertures and the side walls of those apertures with the point of emission or focus point of radiation non-sensical.

In other embodiments (not shown), the apertures, and the side walls of those apertures, may be aligned with radiation constituting a convergent beam of radiation (instead of the divergent beam of radiation shown in FIG. 6), or a virtual focus point, or a focus point of radiation.

The directions in which each aperture extends may be determined from an assessment of the location of the spectral purity filter relative to the radiation beam that is to be directed toward the spectral purity filter. For instance, if the degree of divergence or convergence of radiation constituting a non-parallel beam of radiation is known, and the location of the spectral purity filter is known relative to that beam, the directions in which the apertures should extend can be determined and implemented during the manufacture of the spectral purity filter. The directions in which each aperture extends may be chosen such that the transmission of the second wavelength of radiation (e.g. the desired radiation) through the spectral purity filter is maximized.

Manufacturing methods for spectral purity filters are usually lithography based because of the small dimensions (e.g. depths, or aperture sizes) of the spectral purity filter. In order to create a geometry with variable inclination of the apertures (i.e. to align the apertures with radiation of or constituting a non-parallel beam of radiation) it may be desirable to control the angle at which, for example, the apertures are etched or the like. Methods for etching apertures at an angle have been reported (see, for example, A. A. Ayon, Tailoring etch directionality in a deep reactive ion etching tool, J. Vac. Sci. Technol. B 18 (2000), 1412). A variation in the etched angle from −32° to +32° has been demonstrated. Alternatively, optical manufacturing methods may be used, for example laser drilling, laser photo-ablation or (x-ray) LIGA. Inclined (i.e. angled) apertures may be made by directing a beam of radiation onto a surface of a member used to form the spectral purity filter (e.g. a planar member of the like) at a desired angle, either using a single beam or by using a photo mask or the like.

In FIG. 6, the angles at which the apertures 64 are orientated (i.e. the directions in which the apertures extend) with respect to a normal of the plane defined by the spectral purity filter 60 vary continuously. In other embodiments, the angles at which the apertures are inclined (i.e. the directions in which the apertures extend) may vary discretely. For example, apertures located within a certain ring or area surrounding the center of the spectral purity filter be angled at a certain angle, and this angle may be different for different such rings or areas around the center of the spectral purity filter. Typically, the spectral purity filter 60 may have a thickness between about 5 μm to about 20 μm.

FIG. 7 schematically depicts a side-on and part-section view of a spectral purity filter 70 in accordance with an embodiment of the present invention. The spectral purity filter 70 comprises of a plurality of planar segments 72, the planar segments 72 being fixed to one another at a connection point 74 (which may be a continuation or extension of one or both of the plurality of segments 72). The point of connection 74 may be located in an area where no radiation is collected or is to be collected. For example, the point of connection 74 may be located at a point which coincides with an obscuration commonly found in radiation sources. Each planar segment 72 may be formed from, for example, a foil, plate, membrane or the like.

Each planar segment 72 defines a plane. Apertures 76 are provided in each segment 72. Each aperture 76 is arranged to suppress a first wavelength of radiation (for example, undesirable radiation such as infrared radiation) and to allow at least a portion of a second wavelength of radiation (e.g. desired radiation, such as EUV radiation) to be transmitted through the aperture 76, the second wavelength of radiation being shorter than the first wavelength of radiation. This may be achieved by an appropriate selection of the diameter of the openings of each aperture 76. For example, if the apertures have a diameter which substantially corresponds to a certain wavelength of radiation, that certain wavelength of radiation (for example, radiation of a first wavelength) will be diffracted by the apertures 76, and substantially suppressed (i.e. prevented from being transmitted through the spectral purity filter 70). In general, in order to suppress radiation having the first wavelength, the apertures 76 may have dimensions suitable for diffracting or scattering the radiation having the first wavelength, or absorbing the radiation having the first wavelength in sidewalls of the apertures 76. Typically, the thickness of one or more of the planar segments 72 may be between 5 μm and about 20 μm.

The apertures 76 within each segment 72 extend substantially perpendicularly to the plane defined by that segment 72. The perpendicular direction of extension of the apertures 76 may make the apertures 76 and the spectral purity filter 70 as a whole easier to manufacture, since it may be easier to produce apertures which extend in a perpendicular manner, rather than at an angle to the perpendicular. The apertures may be provided using laser drilling, or by etching.

The planar segments 72 are angled with respect to one another such that the apertures 76 of each segment 72 extend through the spectral purity filter in different directions in order to be substantially in alignment with radiation constituting a non-parallel beam of radiation.

Divergent radiation 68 from emission point or focus point 66 is shown as passing through the apertures 76 provided in the segments 72 of the spectral purity filter 70. Because the apertures 76 extend perpendicularly with respect to a plane defined by each segment 72, a longitudinal axis of each aperture 76 and the side walls of each aperture 76 are not in direct alignment with the emission point or focus point 66. Instead, the longitudinal axis of each aperture 76 and the side walls of each aperture 76 are in substantial alignment with the emission point or focus point 66. Although more radiation 68 (e.g. a few percent) may pass through the spectral purity filter 70 in comparison with a prior art spectral purity filter in which the apertures are not substantially aligned with incoming divergent radiation, some radiation may be incident on and absorbed or scattered by side walls of the apertures 76 due to the lack of direct alignment of the apertures and/or side walls of the apertures with the point of radiation generation 66. The segments 72 may desirably be angled with respect to one another so that the transmission of a second wavelength of radiation with the spectral purity filter is maximized.

The spectral purity filter of FIG. 7 may comprise two segments, as shown in the Figure, or the spectral purity filter may comprise more than two segments. The more segments that are included, the more likely it is that the apertures and side walls of those apertures will have a greater degree of alignment with the radiation that is to be incident of the spectral purity filter, thus increasing the transmission of the second wavelength of radiation through the spectral purity filter.

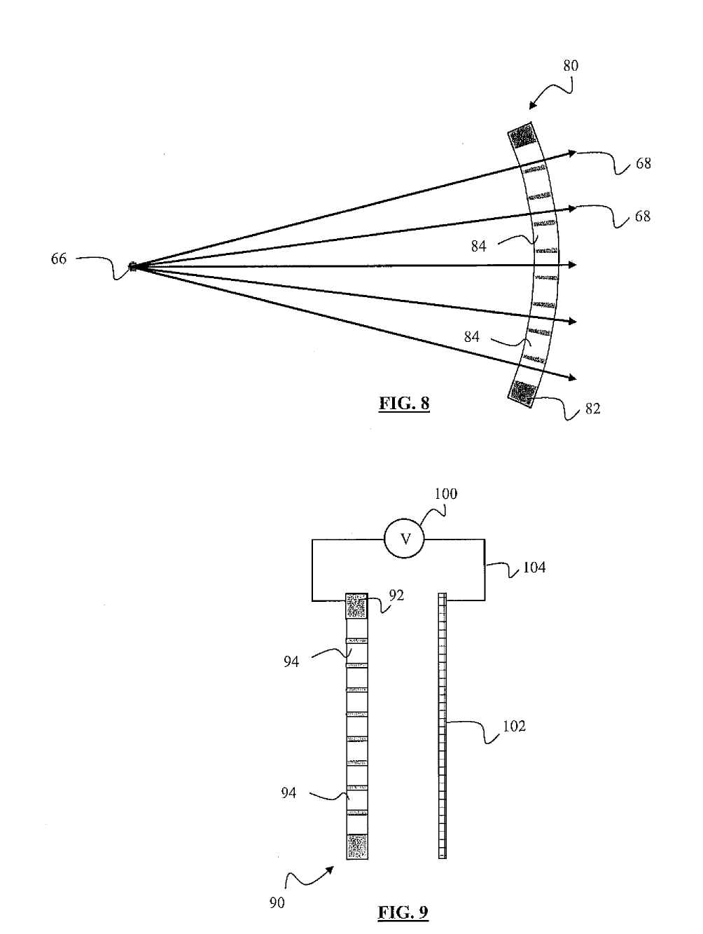

FIG. 8 schematically depicts side-on and part-section view of a spectral purity filter 80 according to an embodiment of the present invention. The spectral purity filter 80 comprises of a curved member 82, or body, which may be or may comprise a curved plate, foil or membrane or the like. Apertures 84 are provided in the spectral purity filter 80, the apertures 84 being aligned substantially perpendicularly with respect to the curve, so that the apertures 84 extend through the spectral purity filter 80 in different directions.

Each aperture 84 is arranged to suppress a first wavelength of radiation (for example, undesirable radiation such as infrared radiation) and to allow at least a portion of a second wavelength of radiation (e.g. desired radiation, such as EUV radiation) to be transmitted through the aperture 84, the second wavelength of radiation being shorter than the first wavelength of radiation. This may be achieved by an appropriate selection of the diameter of the openings of each aperture 84. For example, if the apertures have a diameter which substantially corresponds to a certain wavelength of radiation, that certain wavelength of radiation (for example, radiation of a first wavelength) will be diffracted by the apertures 84, and substantially suppressed (i.e. prevented from being transmitted through the spectral purity filter 80). In general, in order to suppress radiation having the first wavelength, the apertures 84 may have dimensions suitable for diffracting or scattering the radiation having the first wavelength, or absorbing the radiation having the first wavelength in sidewalls of the apertures 84.

The apertures 84 may be provided by angled etching, by an optical method, as described above. Alternatively, the apertures 84 may be provided in a planar member. The apertures 84 may extend substantially perpendicularly to a plane defined by that planar member. The planar member can then be bent to form the curved member 82. The bending of the planar member to form the curved member 82 results in the apertures 84, and the side walls of those apertures 84, being angled, and this angle (or those angles) can be selected to align with the location of the point of emission or focus point 66 of radiation 68 by appropriate curvature of the curved member 82. As described above in relation to FIG. 6, such alignment allows radiation 68 to readily pass through the apertures 84, the radiation 68 not being incident on and being absorbed or scattered by side walls of the apertures 84. Typically, the thickness of the curved member 82 may be between 5 μm and about 20 μm.

The degree of curvature of the spectral purity filter is desirably such that the transmission of the second wavelength of radiation through the spectral purity filter is maximized.

In the embodiments of the present invention described above, the transmission of radiation (e.g. a second wavelength of radiation) through apertures of the spectral purity filter may be increased in comparison with prior art spectral purity filters. The apertures of the spectral purity filters of embodiments of the present invention are substantially aligned with radiation constituting a non-parallel beam of radiation to increase the transmission of radiation through the apertures. Due to such alignment, the depth of the apertures (or the lengths of the side walls of the apertures) and thus the depth of the spectral purity filters as a whole may be increased in order to increase suppression of the undesirable radiation (e.g. radiation having the first wavelength) and/or the mechanical robustness of the spectral purity filter (which may include, for example, the heat bearing capacity of the spectral purity filter).

In some embodiments, where the side walls of the apertures are not in alignment with the incoming radiation, an increase in the depth of the apertures may result in a slight decrease in the transmission of radiation through those apertures due to absorption and scattering or the like of radiation. However, in embodiments where the side walls of apertures are also in alignment with the incoming radiation, an increase in the depth of the apertures will not result in a decrease in transmission of radiation through those apertures.

In FIG. 8, bending of a spectral purity filter was described to ensure that the apertures of a spectral purity filter were angled to such an extent that they were substantially aligned with an incoming beam of non-parallel radiation. Bending might be achieved by the use of one or more actuators in physical contact with the spectral purity filter. However, due to an inherent fragility of spectral purity filters, bending using such contact is typically hard to achieve. It may be difficult to bend the spectral purity filter using such contact without damaging or destroying it. The spectral purity filter could be formed in an initially curved manner. However, it is often difficult to manufacture a curved member having the dimensions required in a typical spectral purity filter (e.g. spectral purity filter depth and aperture diameter).

One or more potential problems referred to above (or in the prior art in general) may be obviated or mitigated by the provision of a spectral purity filter arrangement according to an embodiment of the present invention. The spectral purity filter arrangement may comprise a spectral purity filter. The spectral purity filter may comprise apertures extending through the spectral purity filter, each aperture being arranged to suppress a first wavelength of radiation (e.g. radiation to be suppressed, such as infrared radiation) and to allow at least a portion of a second wavelength of radiation (e.g. desirable radiation, such as EUV radiation) to be transmitted through the aperture, the second wavelength of radiation being shorter than the first wavelength of radiation. In general, in order to suppress radiation having the first wavelength, the apertures may have dimensions suitable for diffracting or scattering the radiation having the first wavelength, or absorbing the radiation having the first wavelength in sidewalls of the apertures. The spectral purity filter is initially substantially planar, the apertures of the spectral purity filter extending substantially perpendicularly to that plane. The spectral purity filter arrangement further comprises a deformation arrangement for deforming the spectral purity filter. The deformation arrangement is arranged, in use, to deform the spectral purity filter and to form a substantially curved spectral purity filter. When the spectral purity filter is curved, the apertures extend through the spectral purity filter in different directions in order to be substantially in alignment with radiation constituting a non-parallel beam of radiation. The deformation arrangement comprises an electrostatic arrangement. The use of electrostatics avoids the need to make physical contact with the spectral purity filter in order to bend the spectral purity filter, and thus avoid the risks of damaging the spectral purity filter associated with such physical contact.

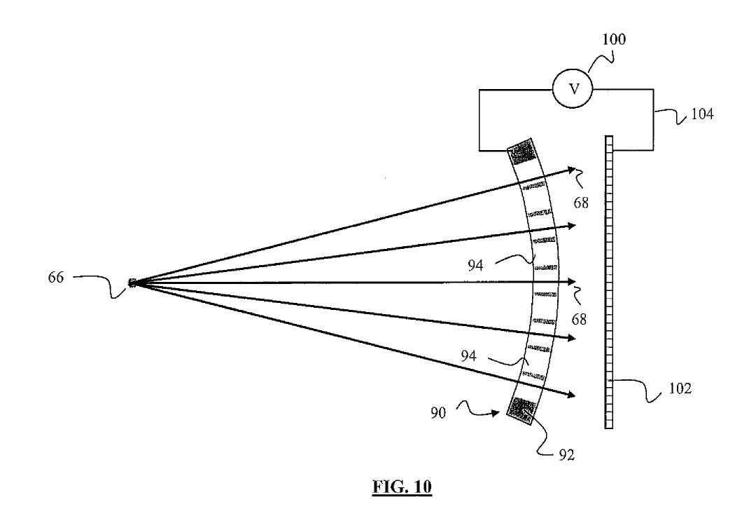

A specific embodiment of the present invention will now be described, by way of example only, with reference to FIGS. 9 and 10.

FIG. 9 schematically depicts a spectral purity filter arrangement according to an embodiment of the present invention. A spectral purity filter 90 is provided. The spectral purity filter 90 comprises of a planar member 92 in the form of a plate, membrane, foil or the like. Provided in the planar 92 are a plurality of apertures 94 which extend through the planar 92 substantially perpendicularly to the plane defined by the planar member 92. Typically, the thickness of one or more of the planar member 92 may be between 5 μm and about 20 μm.

Each aperture 94 is arranged to diffract a first wavelength of radiation (for example, undesirable radiation such as infrared radiation) and to allow at least a portion of a second wavelength of radiation (e.g. desired radiation, such as EUV radiation) to be transmitted through the aperture 94, the second wavelength of radiation being shorter than the first wavelength of radiation. This may be achieved by an appropriate selection of the diameter of the openings of each aperture 94. For example, if the apertures have a diameter which substantially corresponds to a certain wavelength of radiation, that certain wavelength of radiation (for example, radiation of a first wavelength) will be diffracted by the apertures 94, and substantially suppressed (i.e. prevented from being transmitted through the spectral purity filter 90). In general, in order to suppress radiation having the first wavelength, the apertures 94 may have dimensions suitable for diffracting or scattering the radiation having the first wavelength, or absorbing the radiation having the first wavelength in sidewalls of the apertures 94.

The spectral purity filter 90 is in connection with a deformation arrangement. The deformation arrangement comprises an electrostatic arrangement. The electrostatic arrangement comprises a voltage source 100 and an electrode configuration 102. The voltage source 100 is in electrical connection 104 with the spectral purity filter 90 and the electrode configuration 102.

The electrode configuration 102 is placed proximal to the spectral purity filter 90. The electrical configuration 102 is located close enough to the spectral purity filter such that, in use, an electrostatic force may be generated which is sufficient to bend the spectral purity filter 90 to a desired degree (for example, to a degree sufficient to ensure that the apertures of the spectral purity filter 90 are substantially in alignment with incoming radiation).

The electrical configuration 102 may be for example a grid (i.e. a mesh) or the like. One, more or all parts of the electrode configuration 102 may be located outside of a beam diameter of the beam of radiation that is incident on the spectral purity filter, in order to avoid parts of the radiation beam being absorbed or scattered by the electrode configuration 102 itself. For instance, the electrode configuration 102 may be provided with a hole or aperture through which the beam of radiation may pass.

In use, a voltage is applied between the spectral purity filter 90 and the electrode configuration 102. An electric field established between the electrode configuration 102 and the spectral purity filter 90 will generate an electrostatic force which is used to curve (i.e. to deform or bend) the spectral purity filter 90. Such bending may be facilitated by fixing in position (e.g. pinning or holding) one or more parts of the spectral purity filter 90, for example or more points on an external diameter of the spectral purity filter, or a holder of the spectral purity filter, for example a frame or the like. The electrostatic force will be counteracted by an elastic force generated within the spectral purity filter until equilibrium is reached and both forces equate to one another. Since the electrostatic force is typically fairly small, it may be necessary to use several kilovolts, or tens of kilovolts, in order to bend the spectral purity filter to a sufficient degree, depending on the mechanical strength of the spectral purity filter. This strength may depend on, for example, the configuration and distribution of apertures in the spectral purity filter, and/or the materials used to form the spectral purity filter.

FIG. 10 shows the spectral purity filter arrangement in use. An electric field has been established between the electrode configuration 102 and the spectral purity filter 90, causing the spectral purity filter 90 to bend. Bending of the spectral purity filter 90 has been undertaken to such an extent that the apertures 94 of the spectral purity filter 90 (and sidewalls of those apertures) are in alignment with radiation 68 of a non-parallel beam of radiation from emission point or focus point 66.

The electrostatic forces generated are attractive. In order to cause the spectral purity filter to bend in an opposite direction, the electrode arrangement may need to be located (or re-located) on an opposite side of the spectral purity filter. An electrode configuration may be located on either side of the spectral purity filter, in order to be able to select which way the spectral purity filter bends in order to, for example, align apertures of the spectral purity filter with either a convergent or divergent incoming beam of radiation, which may coincide with an emission or focus point.

The force applied to the spectral purity filter can be varied by appropriate variation of the voltage applied between the spectral purity filter and the electrode configuration. This allows active control of the degree of curvature of the spectral purity filter. The degree of curvature should ideally be such that the transmission of the second wavelength of radiation through the spectral purity filter (e.g. EUV radiation) should be maximized. A controller may be provided for controlling the voltage source and thereby controlling the deformation and degree of curvature of the spectral purity filter. The controller may be arranged to control the voltage source in response to a feedback signal received by the controller. The feedback signal may be at least indicative of a transmission of the second wavelength of the radiation through the spectral purity filter, or a degree of curvature of a spectral purity filter. For instance, a radiation detector may be located down-stream of the spectral purity filter in order to measure the amount of radiation that has been transmitted by the spectral purity filter. The degree of transmission may be fed back to the controller by way of the feedback signal, and the controller arranged to control the degree of curvature until the feedback signal is indicative of the transmission of the second wavelength of radiation being maximized. Alternatively or additionally, an arrangement may be provided for determining the degree of curvature of the spectral purity filter 90 without reference to the radiation transmitted through the spectral purity filter. For instance, one or more cameras or the like may be used to determine the degree of curvature, and the degree of curvature fed back to the controller using the feedback signal. The controller may control the voltage of the voltage source to ensure that the curvature of the spectral purity filter is at a desired level, detectable by the one or more cameras.

In other embodiments, the voltage source may be in connection with one or more parts of the electrode arrangement, or one or more voltage sources may be provided which are in connection with different parts of the electrode configuration. This may allow more selective or accurate control of the generated electric fields and electrostatic forces, and thus more selective or accurate control of the deformation of the spectral purity filter. The electrode arrangement may be planar, for example a planar grid or mesh or the like. In other embodiment, the electrode arrangement may be curved. In one example, the electrode arrangement may be curved to match, or substantially conform with a desired degree of curvature of the spectral purity filter. Such matching or conformity may allow the distance between the spectral purity filter and the electrode configuration to be reduced or minimized, which may result in a reduction in the voltage levels required to deform the spectral purity filter.

The spectral purity filter or spectral purity filter arrangements described above may be used in any suitable application. For instance, a lithographic apparatus or a radiation source may be provided which incorporates one or more spectral purity filters or a spectral purity filter arrangements as described above.

As described above, the spectral purity filters may be used to suppress radiation having a first wavelength of radiation, and allow the transmission of radiation having a second wavelength of radiation. The first wavelength of radiation may have a wavelength that is in the infrared part of the electromagnetic spectrum. For instance, the first wavelength of radiation may have a wavelength of 10.6 μm. The second wavelength of radiation may have a wavelength that is substantially equal to or shorter than radiation having a wavelength in the EUV part of the electrode electromagnetic spectrum. However, the spectral purity filter may be configured (i.e. the apertures may have dimensions) such that radiation having a different wavelength of radiation is suppressed (e.g. by diffraction, scattering, absorption in sidewalls or the like), and radiation having a different wavelength is allowed to be transmitted through the spectral purity filter. In the above described embodiments, a ‘desired’ (or ‘second’) wavelength of radiation has been described as being a wavelength of radiation in or below the EUV range of the electromagnetic spectrum. Furthermore, an ‘undesired’ (or ‘first’) wavelength of radiation has been described as a wavelength of radiation in the infrared part of the electromagnetic spectrum. It will be appreciated that the present invention is also applicable to other wavelengths of radiation that may be desired or undesired.

Generally, the apertures may have a diameter in the range of about 2 μm to about 10 μm, more specifically in the range of about 2 μm to about 10 μm and even more specifically in the range of about 2 μm to about 10 μm. Depending on other parameters of the spectral purity filter, such apertures may be suitable for suppressing infrared wavelengths. However, alternatively, embodiments of the spectral purity filter according to the invention may include apertures having deviating diameters.

Although the above description of embodiments of the invention relates to a radiation source which generates EUV radiation (e.g. 5-20 nm), the invention may also be embodied in a radiation source which generates ‘beyond EUV’ radiation, that is radiation with a wavelength of less than 10 nm. Beyond EUV radiation may for example have a wavelength of 6.7 nm or 6.8 nm. A radiation source which generates beyond EUV radiation may operate in the same manner as the radiation sources described above. The invention is also applicable to lithographic apparatus that uses any wavelength of radiation where it is desired to separate, extract, filter, etc. one or more wavelengths of radiation from another one or more wavelengths of radiation. The described spectral purity filter may be used, for example, in a lithographic apparatus or a radiation source (which may be for a lithographic apparatus). The invention may also be applied to fields and apparatus used in fields other than lithography.

The description above is intended to be illustrative, not limiting. Thus, it will be apparent to one skilled in the art that modifications may be made to the invention as described without departing from the scope of the claims set out below.

What is claimed is:

1. A spectral purity filter, comprising:
a plurality of apertures extending through a member of the spectral purity filter,
the apertures being arranged to suppress a first wavelength of radiation and to allow at least a portion of a second wavelength of radiation to be transmitted through the apertures, the second wavelength of radiation being shorter than the first wavelength of radiation;
wherein the apertures extend through the member in different directions in order to be substantially in alignment with radiation constituting a non-parallel beam of radiation.

2. The spectral purity filter of claim 1, wherein the member comprises a plurality of planar segments defining a plurality of planes, the apertures within each segment extending substantially perpendicular to the plane defined by the corresponding segment, and the planar segments being angled with respect to one another such that the apertures extend through the member in different directions.

3. The spectral purity filter of claim 1, wherein the member is substantially curved, the apertures being aligned substantially perpendicularly with respect to the curve, such that the apertures extend through the member in different directions.

4. The spectral purity filter of claim 1, wherein the apertures have sidewalls, the sidewalls being arranged to be substantially in alignment with radiation constituting a non-parallel beam of radiation.

5. The spectral purity filter of claim 1, wherein the direction in which the apertures extend is arranged to be in substantial alignment with a point.

6. The spectral purity filter of claim 1, wherein the first wavelength of radiation has a wavelength that is in the infrared part of the electromagnetic spectrum.

8. The spectral purity filter of claim 1, wherein the second wavelength of radiation has a wavelength that is substantially equal to or shorter than radiation having a wavelength in the EUV part of the electromagnetic spectrum.

9. A spectral purity filter arrangement, comprising:
a spectral purity filter, comprising:
a plurality of apertures extending through a member, the apertures being arranged to suppress a first wavelength of radiation and to allow at least a portion of a second wavelength of radiation to be transmitted through the aperture, the second wavelength of radiation being shorter than the first wavelength of radiation, the member being substantially planar and defining a plane, the apertures extending substantially perpendicularly to the plane; and
a deformation arrangement constructed and arranged to deform the member in order to, in use, form a substantially curved member, and such that the apertures extend though the member in different directions in order to be substantially in alignment with radiation constituting a non-parallel beam of radiation, the deformation arrangement comprising an electrostatic arrangement.

10. The spectral purity filter arrangement of claim 9, wherein the first wavelength of radiation has a wavelength that is in the infrared part of the electromagnetic spectrum.

11. The spectral purity filter arrangement claim 9, wherein the second wavelength of radiation has a wavelength that is substantially equal to or shorter than radiation having a wavelength in the EUV part of the electromagnetic spectrum.

12. A lithographic apparatus, comprising:
lithographic apparatus, comprising:
a radiation source configured to generate radiation;
a spectral purity filter positioned in the radiation source and configured to filter the radiation generated by the radiation source, the spectral purity filter, comprising
a plurality of apertures extending through a member of the spectral purity filter,
the apertures being arranged to suppress a first wavelength of radiation and to allow at least a portion of a second wavelength of radiation to be transmitted through the apertures, the second wavelength of radiation being shorter than the first wavelength of radiation,
wherein the apertures extend through the member in different directions in order to be substantially in alignment with radiation constituting a non-parallel beam of radiation;
a support configured to support a patterning device, the patterning device being configured to pattern the radiation filtered by the spectral purity filter into a patterned beam of radiation; and
a projection system configured to project the patterned beam of radiation onto a substrate.

13. The lithographic apparatus of claim 12, further comprising a deformation arrangement constructed and arranged to deform the member of the spectral purity filter in order to, in use, form a substantially curved member, and such that the apertures extend though the member in different directions in order to be substantially in alignment with radiation constituting a non-parallel beam of radiation, the deformation arrangement comprising an electrostatic arrangement.

14. A radiation source configured to generate radiation, the radiation source comprising:
a spectral purity filter configured to filter the radiation generated by the radiation source, the spectral purity filter, comprising
a plurality of apertures extending through a member of the spectral purity filter,
the apertures being arranged to suppress a first wavelength of radiation and to allow at least a portion of a second wavelength of radiation to be transmitted through the apertures, the second wavelength of radiation being shorter than the first wavelength of radiation,
wherein the apertures extend through the member in different directions in order to be substantially in alignment with radiation constituting a non-parallel beam of radiation.

15. The radiation source of claim 14, further comprising a deformation arrangement constructed and arranged to deform the member of the spectral purity filter in order to, in use, form a substantially curved member, and such that the apertures extend though the member in different directions in order to be substantially in alignment with radiation constituting a non-parallel beam of radiation, the deformation arrangement comprising an electrostatic arrangement.
